(19) United States
(12) Patent Application Publication
(10) Pub. No.: US 2005/0155809 A1
(43) Pub. Date: Jul. 21, 2005

(54) Mechanical clutch coupling back-up for electric steering system

(76) Inventors: Richard Michael Krzesicki, Ann Arbor, MI (US); Muqtada Husain, Brownstown, MI (US)

Correspondence Address: DICKINSON WRIGHT PLLC, 1901 L. STREET NW, SUITE 800, WASHINGTON, DC, 20036, US

(21) Appl. No.: 10/760,929

(22) Filed: Jan. 20, 2004

(51) Int. Cl. B62D 5/04

(52) U.S. Cl. 180/407

(57) ABSTRACT

A mechanical clutch coupling back-up system for use with a steer-by-wire arrangement in a vehicle is disclosed. The system includes an input shaft, an output shaft, a clutch assembly, and an actuator assembly. In the event of vehicle power failure, the actuator assembly permits the clutch assembly to provide a mechanical coupling of the input shaft and the output shaft thereby allowing the operator to drive the vehicle without the steer-by-wire system. The actuator assembly includes an actuator and the clutch assembly includes a movable clutch collar which is movable between a disengaged position when vehicle power is present and an engaged position when vehicle power is absent.

### BACKGROUND OF THE INVENTION

The present invention relates generally to a back-up for electric steering systems. More particularly, the present invention relates to a clutch mechanism to be used as a back-up arrangement for a steer-by-wire system in a vehicle.

Traditional vehicle steering systems include a steering wheel, a steering column, and an axle with steerable wheels which utilize a rack-and-pinion steering rack arrangement or a steering gear box. According to known arrangements, rotational motion introduced by the driver at the steering wheel is mechanically transmitted directly to the steering mechanism via the steering column. In the early days of vehicles the steering column was little more than an elongated steering shaft with a steering wheel attached at one end and a steering arm attached at the other end for operative engagement with the steerable wheels. Developments in automotive technology enabled designers to modify the early single, straight shaft into an array of linked shafts, thus allowing flexibility in packaging and steering column placement. Such mechanical steering mechanisms have generally been power assisted by hydraulic or electrical assist units.

Regardless of the design, traditional mechanical steering arrangements suffer from limitations in design flexibility because of the necessity of a direct mechanical linkage. To overcome limitations presented by known mechanical steering arrangements, steer-by-wire systems have been developed which eliminate the direct mechanical connection between the steering wheel and the steering mechanism by replacing the mechanical shaft connections with electrical or wire connections. In addition to offering increased design flexibility, the steer-by-wire system offers weight reduction by eliminating the large mechanical linkage conventionally associated with known mechanical steering systems. This savings in weight produces a lighter, more fuel-efficient vehicle.

The steer-by-wire system uses electrical actuators connected to the steerable wheels of the vehicle and a control unit to turn the wheels and to control the angle to which the wheels are turned. Electronic components and electronic systems are also added to the steer-by-wire system to enable communication between steering components.

While removal of the direct mechanical link traditionally associated with mechanical steering systems creates new design flexibility, this absence of such a link presents safety concerns in the event of the failure of the power system of the vehicle. In order to overcome this concern, a mechanical back-up system is required that senses electrical failure and responds in such a way that a mechanical linkage is created to thereby enable the driver to maintain some level of steering control over the vehicle even in the event of electrical failure. There have been proposals to provide a mechanical back-up for the steer-by-wire system yet there remains opportunity for improvement of known systems.

### SUMMARY OF THE INVENTION

The present invention provides a mechanical back-up arrangement for use with a steer-by-wire system that provides improvements over known systems. The arrangement of the present invention generally includes, in conjunction with a steer-by-wire system, a steering column assembly that includes an input shaft and an output shaft. The input shaft is connected to the vehicle steering wheel and is thus rotatable by a vehicle operator. The output shaft is mechanically coupled to the steerable axle of the vehicle. The arrangement also includes a clutch assembly that is movable between a disengaged mode when the steer-by-wire system is active or is powered and a disengaged mode when the steer-by-wire system is inactive because of the loss of vehicle power. An actuator assembly is provided that responds to the power status of the vehicle and moves the clutch assembly, via a linkage, accordingly. If power is directed to the actuator assembly, the clutch assembly is maintained in its disengaged mode, whereby no mechanical linkage exists between the input shaft and the output shaft and the driver may rely on the vehicle's steer-by-wire system to control vehicle direction. If there is a general power failure in the vehicle, the actuator releases the clutch assembly from its disengaged position and the input shaft and the output shaft are mechanically linked.

The clutch assembly of the present invention includes a clutch collar that is axially movable between disengaged and engaged positions. The movement of the clutch collar is dictated by the actuator assembly, which responds to the presence or absence of vehicle electrical power. A biasing element is provided in conjunction with the clutch assembly and acts upon the clutch collar to move it into its engaged position in the event that vehicle power loss releases the actuator assembly.

The arrangement of the present invention offers a positive mechanical back-up for a steer-by-wire system that is efficient, is of relatively low weight, and demonstrates relatively low maintenance. The back-up arrangement of the present invention is also relatively compact, thus providing packaging advantages over known arrangements.

Further scope of the applicability of the present invention will become apparent from the following detailed description, claims and drawings. However, it should be understood that the detailed description and specific examples, while indicating preferred embodiments of the invention, are given for illustrative purposes only, since various changes and modifications within the spirit and scope of the invention will become apparent to those skilled in the art.

### BRIEF DESCRIPTION OF THE DRAWINGS

The present invention will become more fully understood from the detailed description given here below, in the appended claims, and in the accompanying drawings in which:

FIG. 1 is a perspective view of a steer-by-wire steering column and steering gear arrangement and including a back-up arrangement according to the present invention;

FIG. 2 is a perspective view of a first embodiment of the clutch assembly for a steer-by-wire system of the present invention illustrating the clutch coupling and actuator assembly;

FIG. 3 is a side elevational and partially sectional view of the first embodiment of the present invention shown in FIG. 2 with the clutch assembly in its disengaged position;

FIG. 4 is a side elevational view of the first embodiment of the present invention similar to the view shown in FIG. 3 but without the clutch lever and actuator;

FIG. 5 is a view of the first embodiment of the present invention similar to that of FIG. 3 but showing the clutch assembly in its engaged position;

FIG. 6 is a sectional view of a second embodiment of the clutch assembly for a steer-by-wire system of the present invention illustrating the clutch assembly in its disengaged position;

FIG. 7 is a view of the second embodiment of the present invention similar to that of FIG. 6 but showing the clutch assembly in its engaged position;

FIG. 8 is a partially sectional view of a third embodiment of the clutch assembly for a steer-by-wire system of the present invention illustrating the clutch assembly in its disengaged position;

FIG. 9 is an exploded view of the clutch components of the third embodiment of the present invention;

FIG. 10 is a view of the third embodiment of the present invention similar to that of FIG. 8 but showing the clutch assembly in its engaged position;

FIG. 11 is an end view of the clutch assembly of the third embodiment of the present invention shown in FIGS. 8 through 10 taken along lines 11-11 of FIG. 8;

FIG. 12 is a side elevational, partially shadowed illustration of a fourth embodiment of the present invention illustrating the clutch assembly in its disengaged position; and

FIG. 13 is a view of the fourth embodiment of the present invention similar to that of FIG. 12 but showing the clutch assembly in its engaged position.

### DETAILED DESCRIPTION OF THE PREFERRED EMBODIMENTS

The drawings disclose the preferred embodiment of the present invention. While the configurations according to the illustrated embodiment are preferred, it is envisioned that alternate configurations of the present invention may be adopted without deviating from the invention as portrayed. The preferred embodiments are discussed hereafter.

In general, the present invention relates to back-up arrangements for steer-by-wire systems for vehicles. Four embodiments of the present invention are contemplated, as set forth below. While each of these embodiments offers certain distinct design features, each of the embodiments is nevertheless consistent with the overall teaching of the present invention which is to offer improvements over the prior art in terms of reduced weight, low production and maintenance costs, and high reliability. In addition, each of the embodiments provides an efficient system that is characterized in having significant mechanical advantage which results in the need for only upon slight movement of the clutching assembly to accomplish engagement of the mechanical steering back-up through clutch coupling.

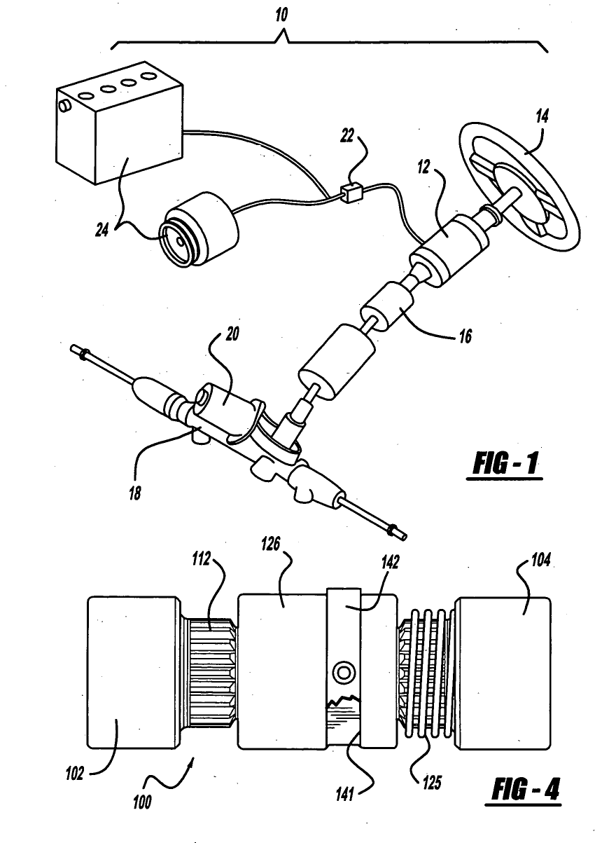

With reference to FIG. 1, this view illustrates a perspective view of the steer-by-wire steering column and steering gear assembly according to the present invention, generally illustrated as 10. The assembly 10 includes a clutch coupling 12, an associated steering wheel 14, a mechanical steering linkage and steering gear assembly 16, and a road wheel steering assembly 18. An electronic control unit 20 is provided to turn the wheels in response to the steer-by-wheel system.

A sensor 22 is provided in electrical contact with the clutch coupling system 12 and in connection with a power source 24 comprised of the power supply and the alternator. The sensor 22 responds to the presence of electrical power in the vehicle system and transmits this information to the clutch coupling system 12 which maintains the clutch in a disengaged position so long as power is present. If no power is directed to the sensor 22 then no power can be transmitted to the clutch coupling system 12 and a mechanical engagement occurs as a back-up to the steer-by-wire system. It is to be noted that the arrangement presented in FIG. 1 is only exemplary and that other connective mechanical and electronic arrangements may be made.

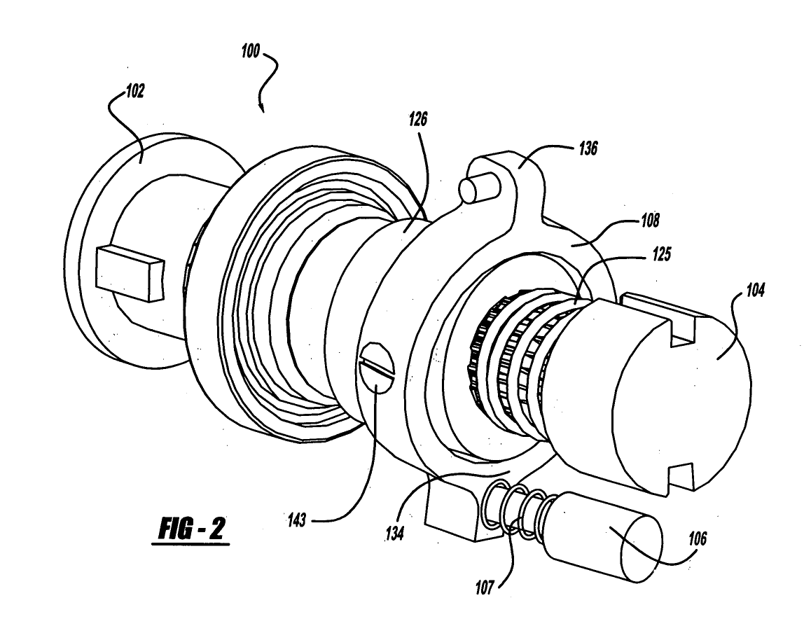

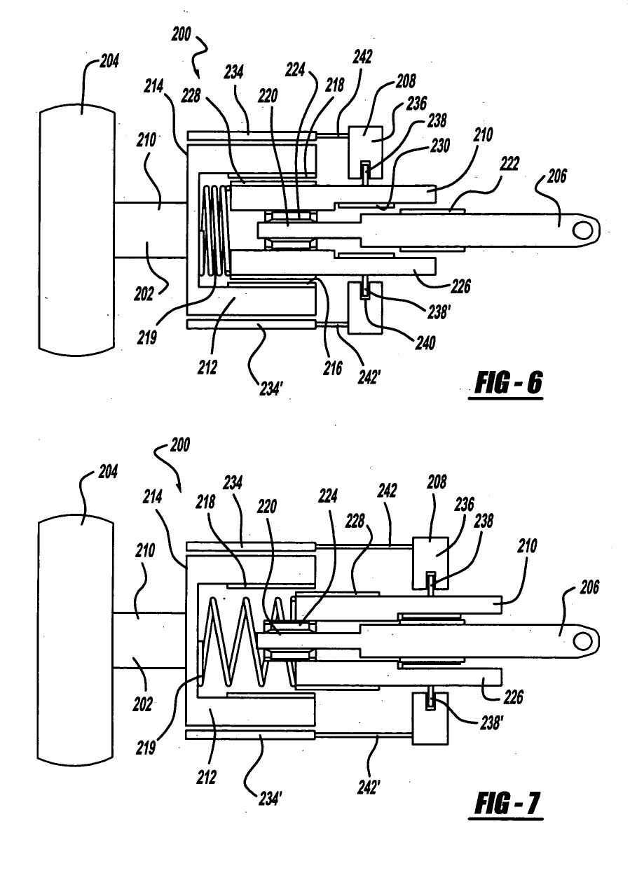

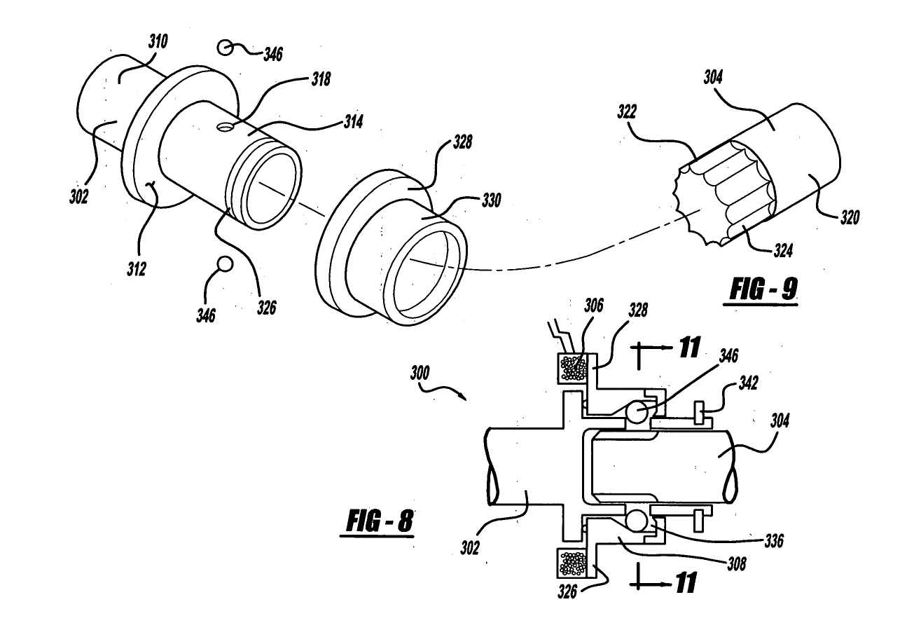

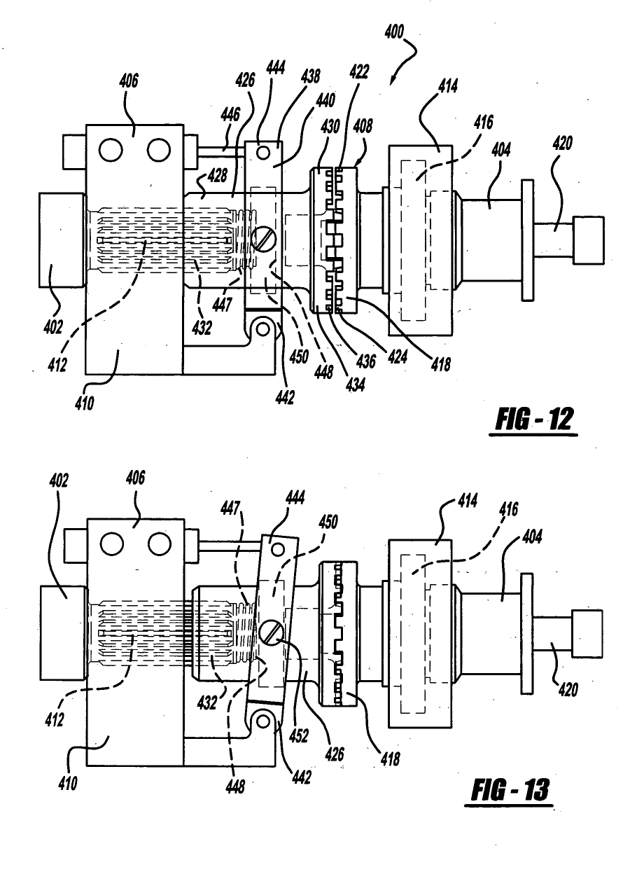

FIGS. 2 through 13 illustrate various approaches to resolution of the problems associated with known clutch back-up arrangements for steer-by-wire systems. There are four embodiments presented and discussed herein. In brief, FIGS. 2 through 5 illustrate a first embodiment of the present invention; FIGS. 6 and 7 illustrate a second embodiment of the present invention; FIGS. 8 through 11 illustrate a third embodiment of the present invention; and FIGS. 12 and 13 illustrate a fourth embodiment of the present invention. While having some different features, the four embodiments shown and discussed all illustrate an improved, light-weight, well-packaged, and readily manufactured arrangement that includes an actuator (in the form of a solenoid or a hydraulically- or pneumatically-operated piston) which is ordinarily engaged when the vehicle power system is operating and a mechanical clutch that is engaged when the power system fails.

### First Preferred Embodiment

With respect to the first embodiment shown in FIGS. 2 through 5, a clutch arrangement, generally illustrated as 100, is shown. The arrangement 100 includes an input shaft 102 connected with a steering wheel (not shown), an output shaft 104 mechanically linked to the vehicle's steering column shaft (not shown), an actuator 106, and a clutch assembly 108. Both the input shaft 102 and the output shaft 104 are axially fixed.

The input shaft 102 is mechanically and directly connected with the steering wheel in a known manner. Rotational movement from the steering wheel directly and at all times effects an equal degree of rotational movement of the input shaft 102. As illustrated in FIGS. 3, 4 and 5, the input shaft 102 includes a splined portion 110. Formed on the splined portion 110 is a pair of sets of external spaced-apart splines 112, 114. A gap 116 exists between the sets of external splines 112, 114.

The output shaft 104 is mechanically and directly connected with the vehicle's steering column shaft. The output shaft 104 includes a splined portion 118. Formed on the splined portion 118 is a pair of sets of spaced-apart external splines 120, 122. A gap 124 exists between the sets of splines 120, 122. An engagement biasing element or spring 125 is provided approximately about the set of splines 122 and provides a biasing force as will be described below.

The clutch assembly 108 consists of a tubular clutch collar 126 and a clutch lever 128. The tubular clutch collar 126 has a long axis which is axially aligned with the long axes of the input shaft 102 and the output shaft 104. The clutch collar 126 includes a pair of spaced-apart internal splines 130, 132. The spacing of the sets of internal splines 130, 132 is roughly equal to the spacing between the sets of external splines 112, 120. The clutch lever 128 includes a clutch lever body 134 having a pivot end 136 and an actuator end 138. The pivot end 136 is pivotably attachable to a fixed point on the vehicle. The actuator end 138 is operably attached to the actuator 106 by way of a linkage 140. The actuator 106 includes a return spring 107.

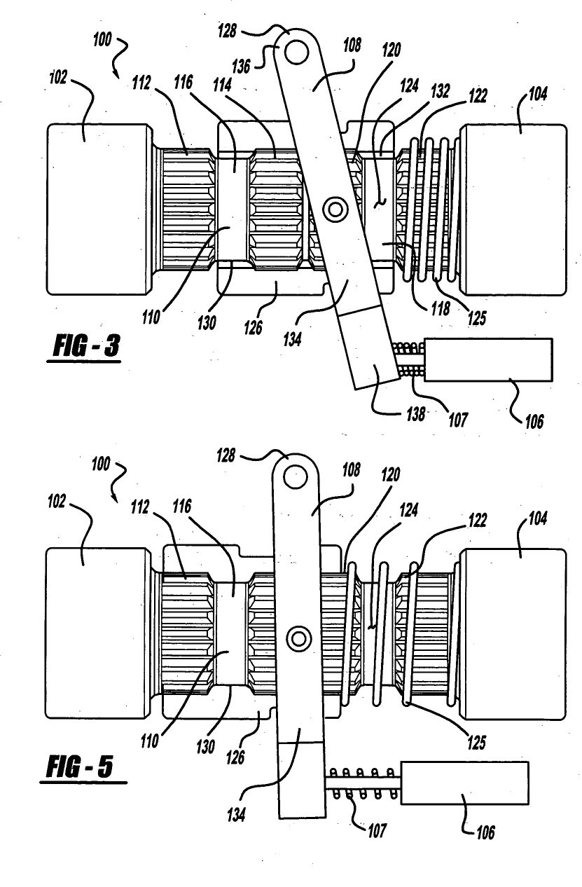

As shown in FIG. 4, a peripheral groove 141 is defined in the clutch collar 126. A ring 142 is rotatably fitted in the peripheral groove 141. The clutch lever 128 is operably attached to the ring 142 by a fastener 143 which is shown in FIG. 2. This fastening arrangement allows the clutch collar 126 to rotate with the input shaft 102 and the output shaft 104 when the clutch is engaged as described below while still supporting the clutch lever 128.

As previously noted, the actuator 106 may be a solenoid or may be a hydraulically- or pneumatically-operated piston. The preferred embodiment, which is not intended to be a limiting embodiment, is that of a solenoid, and the present invention will be described accordingly. The hydraulically- or pneumatically-operated piston configuration, while not described in detail, may be designed as needed consistent with the objects of the present invention.

FIG. 3 illustrates the clutch assembly 108 in its disengaged position. The actuator 106 is in the activated mode, that is, if a solenoid, vehicle power is present and is working to activate the solenoid in a known manner. In its activated mode, the linkage 140 is in its compressed position, thus positioning the clutch collar 126 approximately mid-way over the splined portions 110, 118 and the sets of internal splines 130, 132. In this position the clutch assembly 108 is in its neutral or resting position such that the set of internal splines 130 is generally disposed in the gap 116 formed on the splined portion 110 of the input shaft 102 and the set of internal splines 132 is generally disposed in the gap 124 formed on the splined portion 118 of the output shaft 104. Thus positioned, the input shaft 102 is allowed to freely rotate independent of the output shaft 104 and the vehicle may be operated by its steer-by-wire system.

In the event that the there is a power loss in the vehicle or if the actuator 106 is otherwise deactivated, force is removed from the linkage 104 and the biasing force of the spring 125 acts on the clutch assembly 108 by moving the clutch collar 126 to its engaged position illustrated in FIG. 5. In this position the set of internal splines 130 is moved into engagement with the set of external splines 112 and the set of internal splines 132 is simultaneously moved into engagement with the set of set of external splines 120. Once the actuator 106 is reactivated the clutch assembly 108 is returned to its disengaged position as shown in FIG. 3.

### Second Preferred Embodiment

FIGS. 6 and 7 illustrate a second embodiment of the clutch arrangement of the present invention, generally illustrated as 200. The arrangement 200 includes an input assembly 202 connected with a steering wheel 204, an output shaft 206 mechanically linked to the vehicle's steering column shaft (not shown), an actuator 208, and a clutch assembly 210. The input assembly 202 and the output shaft 206 are not axially movable with respect to each other.

The input assembly 202 includes a shaft 210 that is mechanically and directly connected with the steering wheel 204. Rotational movement from the steering wheel 204 directly and at all times effects an equal degree of rotational movement of the input assembly 202. The input assembly 202 further includes a clutch coupler 212 having a closed end 214 fixed to the shaft 210 and an open end 216. Formed within the open end 216 is a set of internal splines 218. An engagement biasing element or spring 219 within the clutch coupler 212 and provides a biasing force as will be described below.

The output shaft 206 is mechanically and directly connected with the vehicle's steering column shaft The output shaft 206 includes a supporting end 220 and further includes a set of external splines 222. A bearing element 224 is mounted on the supporting end 220. The bearing element 224 may be a roller bearing.

The clutch assembly 210 consists of a tubular clutch collar 226. The tubular clutch collar 226 has a long axis which is axially aligned with the long axes of the input assembly 202 and the output shaft 206. The clutch collar 226 includes a set of external splines 228 and a set of internal splines 230. A bearing surface 232 is formed on the inner wall of one end of the tubular clutch collar 226. The space between the set of internal splines 218 and the set of external splines 222 is substantially equivalent to the space between the external splines 228 and the internal splines 230. The set of external splines 228 are in constant engagement with the set of internal splines 218 of the clutch coupler 212 regardless of whether the clutch assembly 210 is engaged or disengaged as will be discussed below.

The actuator 208 of the second embodiment illustrated in FIGS. 6 and 7 is of the solenoid type and includes a pair of actuators 234, 234′ and an annular ring 236. A pair of engagement pins 238, 238′ extend from the top side and bottom side of the tubular clutch collar 226. The engagement pins 238, 238′ engage an internal annular slot 240 formed within the annular ring 236. The configuration of the internal annular slot 240 permit the engagement pins 238, 238′ to move readily therein. Because the clutch collar 226 is in continuous engagement with the clutch coupler 212 it exhibits the same rotational movement as the steering wheel 204. The free movement of the engagement pins 238, 238′ within the internal annular slot 240 enables the free rotation of the collar 226 relative to the annular ring 236.

The solenoids 234, 234′ are linked respectively to the annular ring 236 by a pair of linkages 242, 242′.

FIG. 6 illustrates the clutch assembly 210 in its disengaged position. The actuators 234, 234 (which, according to the preferred arrangement, are solenoids, although a piston arrangement may be usable as well) are shown in their activated mode in which vehicle power is present. In the activated mode, the linkages 242, 242′ are drawn into the actuators 234, 234′ respectively, thus drawing the collar 226 toward and substantially into the clutch coupler 212. The set of internal splines 218 of the clutch coupler 212 are in operative engagement with the set of external splines 228 of the clutch collar 226. However, the set of internal splines 230 of the clutch collar 226 are out of engagement with the set of external splines 222 of the output shaft 206. The bearing element 224 is in continuous engagement with the bearing surface 232 of the clutch coupler 212 and provides for constant axial alignment of the output shaft 206 relative to the clutch collar 226. In this position the clutch assembly 210 is in its neutral or resting position. Thus positioned, the input assembly 202 is allowed to freely rotate independent of the output shaft 206 and the vehicle may be readily operated by its steer-by-wire system.

Should the vehicle's power system fail or if the actuators 234, 234′ are otherwise deactivated, force is removed from the linkages 242, 242′ and the biasing force of the spring 219 acts on the clutch assembly 210 by forcing the clutch collar 226 to its engaged position as illustrated in FIG. 7. In this position the set of internal splines 230 of the clutch collar 226 is moved into engagement with the set of external splines 222 formed on the output shaft 206 and a continuous mechanical connection between the input assembly 202 and the output shaft 206 and the vehicle may be readily operated through mechanical steering. Once the actuators 234, 234′ are reactivated the clutch assembly 210 is returned to its disengaged position as shown in FIG. 6.

### Third Preferred Embodiment

The third embodiment of the clutch assembly for use as a back-up system in a steer-by-wire steering system according to the present invention is illustrated in FIGS. 8 through 11. With respect to the third embodiment shown in these figures, a clutch arrangement, generally shown as 300, is shown. The arrangement 300 includes an input shaft 302 connected with a steering wheel (not shown), an output shaft 304 mechanically linked to the vehicle's steering column shaft (not shown), an actuator assembly 306, and a clutch assembly 308. Both the input shaft 302 and the output shaft 304 are axially fixed.

The input shaft 302 is mechanically and directly connected with the steering wheel in a known manner. Rotational movement of the steering wheel directly and at all times effects an equal degree of rotational movement of the input shaft 302. As illustrated in FIGS. 8 through 10, the input shaft 302 includes a shaft portion 310 that is connected to the steering wheel, a spring support plate 312, and a tubular output shaft receptacle 314 which is formed so as to operatively receive a portion of the output shaft 304. The output shaft receptacle 314 includes a snap-ring groove 316 formed in its distal end and at least a pair of bearing slots 318 defined through the output shaft receptacle 314. The bearing slots 318 are formed between the snap-ring groove 316 and the spring support plate 312.

The output shaft 304 is mechanically and directly connected with the vehicle's steering column shaft. The output shaft 304 includes a steering column shaft end 320 and a bearing receiving end 322. The bearing receiving end 322 includes a series of relatively wide and cupped splines 324 formed thereon.

The clutch assembly 306 includes a clutch collar 326 that includes an annular actuator stop plate 328, an annular body 330, and an annular stop ring 332. The annular stop ring 332 includes a bearing lip 334. The annular body 330 and the annular stop ring 332 could be made from powder metal as two separate pieces which are then fastened by means such as brazing.

The internal juncture between the annular body 330 and the annular stop ring 332, generally illustrated as bearing housing 336, is defined by a conical wall 338 formed within the annular body 330, the bearing lip 334, and an intermediate wall 340 generally formed between the conical wall 338 and the bearing lip 334. An annular bearing engagement wall 341 is formed between the conical wall 338 and the actuator stop plate 328. The clutch collar 326 is capable of axial movement on the output shaft receptacle 314 of the input shaft 302. A snap ring 342 is fitted in a known manner in the snap-ring groove 316 of the input shaft 302 to limit axial movement of the clutch collar 326 on the output shaft receptacle 314. An engagement biasing element or spring 344 is provided between the spring support plate 312 of the input shaft 302 and the annular actuator stop plate 328 of the clutch assembly 306. The spring 344 provides a biasing force as will be described below. Ball bearings 346 are movably disposed within the bearing region 336. While it is shown that there are two ball bearings 346 situated within the bearing housing 336 it is to be understood that a greater number of bearing may be disposed therein.

As previously noted with respect to the embodiments illustrated in FIGS. 2 through 7, the actuator 306 may be a solenoid or may be a hydraulically- or pneumatically-operated piston. The preferred and illustrated embodiment, which is not intended to be a limiting embodiment, is that of a solenoid, and the present invention will be described accordingly. The hydraulically- or pneumatically-operated piston configuration, while not described in detail, may be designed as needed consistent with the objects of the present invention as with the previously-mentioned embodiments of the present invention.

The actuator 306 includes an annular electro-magnetic coil 348. The electromagnetic coil 348, when activated, attracts the annular actuator stop plate 328 of the clutch collar 326. The operations of activation and deactivation and the resulting and respective mechanical clutch disengagement and engagement will now be described with respect to FIGS. 8, 10 and 11.

FIG. 8 illustrates the clutch assembly 308 in its disengaged position. The actuator 306 is in the activated mode, that is, if a solenoid, vehicle power is present and is working to activate the solenoid in a known manner. In its activated mode, and according to the illustrated configuration, the electromagnetic coil 348 has attracted the annular actuator stop plate 328 of the clutch collar 326 such that the stop plate 328 effectively abuts the annular electro-magnetic coil 348. In this disengaged position, the ball bearings 346 are moved well into the bearing housing 336 and are well spaced-apart from the cupped splines 324 of the bearing receiving end 322 of the output shaft 304. This situation is clearly shown in FIG. 11 which is a sectional view of the clutch arrangement 300 taken along lines 11-11 of FIG. 8. Travel of the ball bearings 346 within the bearing housing 336 is limited by the conical wall 338, the intermediate wall 340, and the bearing lip 334. With the ball bearings 346 thus disengaged from the cupped splines 324, the input shaft 302 may be freely rotated independent of the output shaft 304 and the vehicle may be operated by its steer-by-wire system.

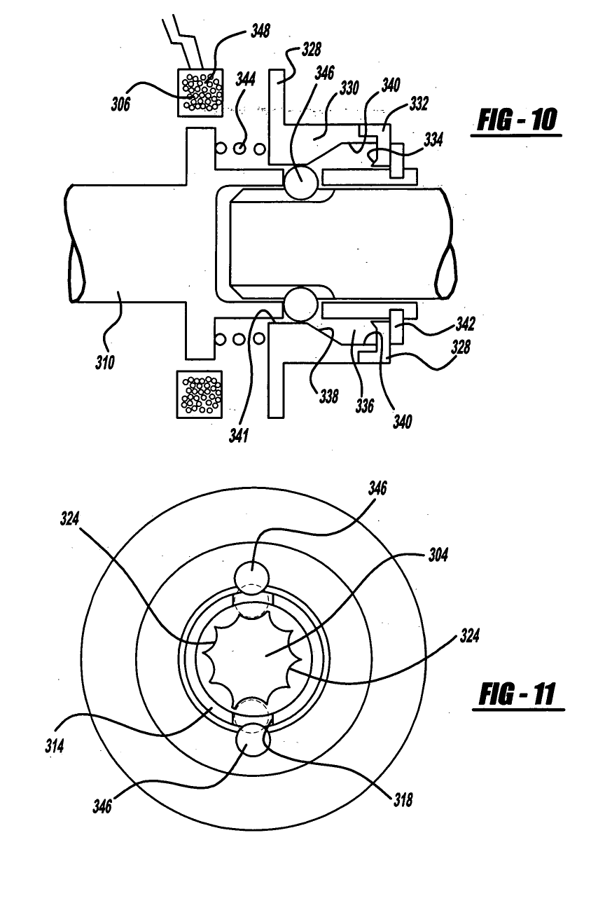

In the event that there is a power loss in the vehicle or if the actuator 306 is otherwise deactivated, force is removed from the actuator 306 and the biasing force of the spring 344 acts on the clutch assembly 308 by moving the clutch collar 326 to its engaged position shown in FIG. 10. As the clutch collar 326 is moved to its engagement position, the ball bearings 346 are forced to ramp inward toward the cupped splines 324 of the output shaft 304, into the bearing slots 318, and are effectively locked into position against the cupped splines 324 by the bearing engagement wall 341 as shown in FIG. 10 and in shadow lines in FIG. 11. Thus engaged, rotation of the input shaft 302 effects simultaneous mechanical rotation of the output shaft 304. Once the actuator 306 is reactivated the clutch assembly 308 is returned to its disengaged position as shown in FIG. 8.

### Fourth Preferred Embodiment

The fourth embodiment of the clutch assembly for use as a back-up system in a steer-by-wire steering system according to the present invention is illustrated in FIGS. 12 and 13 in which a clutch arrangement, generally illustrated as 400, is shown. The arrangement 400 includes an input shaft 402 connected with a steering wheel (not shown), an output shaft 404 mechanically linked to the vehicle's steering column (not shown), an actuator 406, and a clutch assembly 408. Both the input shaft 402 and the output shaft 404 are axially fixed.

The input shaft 402 is mechanically and directly connected with the steering wheel in a known manner. Rotational movement from the steering wheel directly and at all times effects an equal degree of rotational movement of the input shaft 402. The input shaft 402 is rotationally supported by a support member 410 which is provided to attach the clutch arrangement 400 to the vehicle. As illustrated in shadow lines in FIG. 12 and in shadow lines and bold lines in FIG. 13, the input shaft 402 includes a set of external splines 412.

The output shaft 404 is mechanically and directly connected with the vehicle's steering column shaft. The output shaft 404 is rotationally supported by a support member 414 which, as with the support member 410, is provided to attach the clutch arrangement 400 to the vehicle. A bearing 416 is shown in shadow lines and provides a rotational arrangement between the support member 414 and the output shaft 404. The combination of the support member 410 and the support member 414 provide axial alignment to the input shaft 402 and the output shaft 404. The output shaft 404 further includes a coupling end 418 and a driving end 420. The coupling end 418 is an element of the clutch assembly 408 and includes a face 422 which includes a series of spaced-apart teeth 424 formed thereon. The driving end 420 is mechanically connected with the steering shaft of the vehicle.

In addition to the coupling end 418 of the output shaft 404, the clutch assembly 408 includes a clutch collar 426. The clutch collar 426 includes a driven end 428 and a coupling end 430. A set of internal splines 432, shown in shadow lines in FIGS. 12 and 13, is formed internally in the driven end 428 of the clutch collar 426. The set of internal splines 428 of the clutch collar 426 are formed to mate with the set of external splines 412 of the input shaft 402 such that the clutch collar 426 is able to slide axially substantially on the input shaft 402.

The coupling end 430 of the clutch collar 428 further includes a face 434. The face 434 includes a series of spaced-apart teeth 436 formed thereon. The teeth 436 are positioned so as to be selectively matable with the teeth 424 of the face 422 of the output shaft 404.

The clutch assembly 408 further includes a clutch lever 438. The clutch lever 438 includes a clutch lever body 440 having a pivot end 442 and an actuator end 444. The pivot end 442 is attachable to the support member 410 or may be attached to another fixed point on the vehicle. The actuator end 444 is operably attached to the actuator 406 by way of a linkage 446.

As shown in shadow lines, a peripheral groove 448 is defined in the clutch collar 426. A ring 450, also shown in shadow lines, is fitted in the peripheral groove 448. The clutch lever 438 is operably attached to the ring 450 by a fastener 452. This fastening arrangement allows the clutch collar 426 to rotate with the input shaft 402.

As previously noted, the actuator 406 may be a solenoid or may be a hydraulically- or pneumatically-operated piston. The preferred embodiment, which is not intended to be a limiting embodiment, is that of a solenoid, and the present invention will be described accordingly.

FIG. 12 illustrates the clutch assembly 408 in its disengaged position. The actuator 406 is in the activated mode, that is, if a solenoid, vehicle power is present and is working to activate the solenoid in a known manner. In its activated mode, the linkage 446 is in its retracted position, thus positioning the clutch collar 426 in its disengaged position or substantially in abutment with the support member 410. In this position the clutch assembly 408 is in its neutral or teeth 436 of the clutch collar 426 are spaced apart from and are thus disengaged from the teeth 424 of the output shaft 404. Thus situated, the input shaft 402 is allowed to freely rotate independent of the output shaft 404 and the vehicle may be operated by its steer-by-wire system.

In the event that the there is a power loss in the vehicle or if the actuator 406 is otherwise deactivated, force is removed from the linkage 446 and the biasing force of a spring 447 fitted to the input shaft 402 and positioned within a bore defined within the clutch collar 426 acts on the clutch assembly 408 by moving the clutch collar 428 to its engaged position illustrated in FIG. 13. In this position the teeth 436 of the clutch collar 426 are engaged with the teeth 424 of the output shaft 404, thus providing a direct mechanical linkage between the input shaft 402 and the output shaft 404. Once the actuator 106 is reactivated the clutch assembly 408 is returned to its disengaged position as shown in FIG. 12.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

1. A steering assembly for a vehicle comprising:
a steering column assembly including an input shaft rotatable by a vehicle operator and an output shaft mechanically coupled to a steerable axle, said input shaft including a set of splines and said output shaft including a set of splines;
an electric steering system operable in an active mode to operably intercouple said input shaft and said output shaft and in an inactive mode wherein said electric steering system does not operably intercouple said input shaft and said output shaft;
a mechanical steering system selectively operable in an engaged position and a disengaged position, said mechanical steering system including an actuator assembly and an axially movable clutch collar being movable between an engaged position and a disengaged position in response to said actuator assembly, said axially movable clutch collar having a set of splines, said mechanical steering system further including a biasing element for urging said clutch collar to said engaged mode, said actuator assembly maintaining said mechanical steering system coupling said input shaft to rotate with said output shaft when said electric steering system is in said inactive mode in which case said mechanical steering system is in said engaged position wherein said clutch collar being splined to said input shaft and said output shaft while said mechanical steering system is in said engaged position, and said actuator assembly maintaining said output shaft out of mechanical coupling with said input shaft when said electric steering system is in said active mode in which case said mechanical steering system is in said disengaged position.

2. The steering assembly of claim 1 wherein said movable clutch collar is axially movable substantially on said input shaft and is rotatable therewith.

3. The steering assembly of claim 1 wherein said movable clutch collar is axially movable substantially within said input shaft and is rotatable therewith.

4. The steering assembly of claim 1 wherein said actuator assembly includes a power activated actuator, said power activated actuator maintaining said clutch collar in a disengaged position when said electric steering system is in said active mode, said clutch collar being moved into said engaged position by said biasing element when said electric steering system is in said inactive mode.

5. The steering assembly of claim 4 further including a mechanical linkage between said power activated actuator and said clutch collar.

6. The steering assembly of claim 1 wherein said input shaft has a biasing element stop and wherein said biasing element is substantially positioned between said biasing element stop of said input shaft and said clutch collar.

7. The steering assembly of claim 1 wherein said output shaft includes an output shaft clutch face, said output shaft clutch face having a set of output teeth formed thereon, and said clutch collar including a clutch collar clutch face, said clutch collar clutch face having a set of clutch collar teeth formed thereon, said output teeth being matable with said clutch collar teeth when said mechanical steering system is in said engaged position.

8. The steering assembly of claim 1 wherein said actuator assembly includes a solenoid.

9. A steering assembly for a vehicle comprising:
a steering column assembly including an input shaft rotatable by a vehicle operator and an output shaft mechanically coupled to a steerable axle;
an actuator assembly responsive to the presence or absence of electric power in a vehicle, said actuator assembly being in an active mode when electric power is present and an inactive mode when electric power is absent;
a clutch assembly movable between a disengaged position when said actuator assembly is in said active mode and an engaged position when said actuator assembly is in said inactive mode, said clutch assembly comprising a movable clutch collar, said actuator assembly being operably linked to said clutch collar, said clutch collar being movable between said engaged position wherein said input shaft is mechanically connected to said output shaft and said disengaged position wherein said input shaft is mechanically disconnected from said output shaft, said clutch collar being axially movable with respect to said input shaft and said output shaft.

10. The steering assembly of claim 9 wherein said movable clutch collar is axially movable substantially on said input shaft and is rotatable therewith.

11. The steering assembly of claim 9 wherein said movable clutch collar is axially movable substantially within said input shaft and is rotatable therewith.

12. The steering assembly of claim 9 further including a biasing element for urging said clutch collar to said engaged position.

13. The steering assembly of claim 12 wherein said actuator assembly includes a power activated actuator, said power activated actuator maintaining said clutch collar in said disengaged position when said actuator assembly is in the active mode and said biasing element urging said clutch collar into said engaged position when said actuator assembly is in the inactive mode.

14. The steering assembly of claim 13 wherein said input shaft has a biasing element stop and wherein said biasing element is substantially positioned between said biasing element stop of said input shaft and said clutch collar.

15. The steering assembly of claim 9 wherein said input shaft includes a set of splines and said clutch collar includes a set of input splines, said clutch collar being splined to said input shaft at least when said mechanical steering system is in said engaged position.

16. The steering assembly of claim 15 wherein said output shaft includes a set of splines and said clutch collar includes a set of output splines, said clutch collar being splined to said output shaft when said mechanical steering system is in said engaged position.

17. The steering assembly of claim 16 wherein said output shaft includes an output shaft clutch face, said output shaft clutch face having a set of output teeth formed thereon, and said clutch collar includes a clutch collar clutch face, said clutch collar clutch face having a set of clutch collar teeth formed thereon, said output teeth being matable with said clutch collar teeth when said mechanical steering system is in said engaged position.

18. A steering assembly for a vehicle comprising:
a steering column assembly including an input shaft rotatable by a vehicle operator and an output shaft mechanically coupled to a steerable axle, said input shaft including a set of splines and said output shaft including an output shaft clutch face having a set of output teeth formed thereon;
an actuator assembly responsive to the presence or absence of electric power in a vehicle, said actuator assembly being in an active mode when electric power is present and an inactive mode when electric power is absent;
a clutch assembly movable between a disengaged position when said actuator assembly is in said active mode and an engaged position when said actuator assembly is in said inactive mode, said clutch assembly comprising a clutch collar and an actuator linkage linking said actuator assembly to said clutch collar, said clutch collar having a clutch collar clutch face, said clutch collar clutch face having a set of clutch collar teeth formed thereon, said clutch collar being movable between said engaged position wherein said input shaft is mechanically connected to said output shaft and said disengaged position wherein said input shaft is mechanically disconnected from said output shaft, said clutch collar including a set of splines, said clutch collar being connectable to said set of splines of said input shaft, said output teeth being mateed with said clutch collar teeth when said clutch assembly is in its engaged position.

19. The steering assembly of claim 18 wherein said movable clutch collar is axially movable substantially on said input shaft and is rotatable therewith.

20. The steering assembly of claim 19 further including a biasing element for urging said clutch collar to said engaged position and wherein said actuator assembly includes a power activated actuator, said power activated actuator maintaining said clutch collar in said disengaged position when said actuator assembly is in the active mode and said biasing element urging said clutch collar into said engaged position when said actuator assembly is in the inactive mode.
